(19) United States
(12) Patent Application Publication
(10) Pub. No.: US 2017/0061791 A1
(43) Pub. Date: Mar. 2, 2017

(54) AUTOMATED TRAFFIC CONTROL SYSTEM FOR USE IN CONSTRUCTION AND WORK ZONES

(71) Applicant: CONSTRUCTRON, INC., Lemoyne, PA (US)

(72) Inventor: Matthew CHEREWKA, Camp Hill, PA (US)

(21) Appl. No.: 15/256,106

(22) Filed: Sep. 2, 2016

Related U.S. Application Data
(60) Provisional application No. 62/213,309, filed on Sep. 2, 2015.

(51) Int. Cl. G08G 1/0955; G08G 1/09; G08G 1/08

(52) U.S. Cl. CPC G08G 1/0955; G08G 1/08; G08G 1/091

(57) ABSTRACT

A traffic control system, that includes a first modular control unit; a first portable signaling device in communication with the first modular control unit, wherein the first portable signaling device includes at least one display and at least one vehicle-detecting camera; a second modular control unit; a second portable signaling device in communication with the second modular control unit, wherein the second portable signaling device includes at least one display and at least one vehicle-detecting camera; and a mesh network formed between the first modular control unit and the second modular control unit, wherein the mesh network enables completely autonomous functioning of the first portable signaling device in combination with the second portable signaling device for controlling traffic within a work zone in which the first and second portable signaling devices have been placed.

### CROSS-REFERENCE TO RELATED APPLICATIONS

This patent application claims the benefit of U.S. Provisional Patent Application Ser. No. 62/213,309 filed on Sep. 2, 2015 and entitled “Robotic Portable Traffic Control Apparatus and System”, the disclosure of which is hereby incorporated by reference herein in its entirety and made part of the present U.S. utility patent application for all purposes.

### BACKGROUND OF THE INVENTION

The described invention relates in general to systems, devices, and methods for controlling traffic, and more specifically to an automated system which includes various devices for controlling traffic flow into and through construction and work zones, and for monitoring and managing other aspects of construction and work zone activity.

By some estimates, greater than 20% of the major highways in the United States are in poor or mediocre condition and require substantial repairs and maintenance. These estimates exclude the hundreds of thousands of miles of local roads that are not eligible for federal aid and the nearly 25% of existing bridges that are either structurally deficient or functionally obsolete. Despite this reality, government spending on transportation infrastructure has actually decreased significantly over the last decade, due largely to increasing costs associated with materials, labor, and safety. Construction zones on interstate and state highways, secondary routes, and surface roads are among the most dangerous work sites in the United States and elsewhere, largely due to the presence of workers in a dynamic and ever changing environment. Existing traffic control systems include automated flagger assistive devices, or AFADs. AFADs are remotely-operated devices consisting of either a traffic signal or a Stop/Slow sign. AFADs may be operatively coupled to a gate, and may be cart-mounted or trailer-mounted. At least one person, commonly referred to a flagger, is still required to operate the AFAD while standing at a potentially dangerous location having a clear line-of-sight to allow the person to view at least one AFAD. Thus, there is an ongoing need for a highly effective automated traffic control system for use in construction and work zones that will increase safety, increase productivity, and reduce the costs associated with highway and road construction and repair.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first traffic control system is provided. This control system includes a first modular control unit; a first portable signaling device in communication with the first modular control unit, wherein the first portable signaling device includes at least one display and at least one vehicle-detecting camera; a second modular control unit; a second portable signaling device in communication with the second modular control unit, wherein the second portable signaling device includes at least one display and at least one vehicle-detecting camera; and a mesh network formed between the first modular control unit and the second modular control unit, wherein the mesh network enables completely autonomous functioning of the first portable signaling device in combination with the second portable signaling device for controlling traffic within a work zone in which the first and second portable signaling devices have been placed.

In accordance with another aspect of the present invention, a second traffic control system is provided. This control system includes a first modular control unit; a first portable signaling device in communication with the first modular control unit, wherein the first portable signaling device includes at least one display and at least one vehicle-detecting camera; a second modular control unit; a second portable signaling device in communication with the second modular control unit, wherein the second portable signaling device includes at least one display and at least one vehicle-detecting camera; at least one additional modular control unit and at least one additional portable signaling device in communication with the at least one additional modular control unit; and a mesh network formed between the modular control units, wherein the mesh network enables completely autonomous functioning of the signaling devices in combination with one another for controlling traffic within a work zone in which the portable signaling devices have been located.

In yet another aspect of this invention, a third traffic control system is provided. This traffic control system includes a first modular control unit, wherein the first modular control unit includes software that further includes adaptive traffic algorithms or real-time adaptive algorithms; a first portable signaling device in communication with the first modular control unit, wherein the first portable signaling device includes at least one display and at least one vehicle-detecting IP camera; a second modular control unit, wherein the second modular control unit includes software that further includes adaptive traffic algorithms or real-time adaptive algorithms; a second portable signaling device in communication with the second modular control unit, wherein the second portable signaling device includes at least one display and at least one vehicle-detecting IP camera; at least one additional modular control unit and at least one additional portable signaling device in communication with the at least one additional modular control unit, wherein the at least one additional modular control unit includes software that further includes adaptive traffic algorithms or real-time adaptive algorithms; and a mesh network formed between the modular control units, wherein the mesh network enables completely autonomous functioning of the signaling devices in combination with one another for controlling traffic within a work zone in which the portable signaling devices have been located.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is an illustrative view of a first portable signaling device in accordance with an exemplary embodiment of the present invention;

FIG. 2 is an alternate view of the portable signaling device of FIG. 1;

FIG. 3 is an illustrative view of a second portable signaling device in accordance with an exemplary embodiment of the present invention;

FIG. 4 is a first alternate view of the portable signaling device of FIG. 3;

FIG. 5 is a second alternate view of the portable signaling device of FIG. 3;

FIG. 6 is a graphic illustration of a modular control unit in accordance with an exemplary embodiment of the present invention;

FIG. 7 is a first graphic illustration of certain aspects of the traffic control system of the present invention;

FIG. 8 is a second graphic illustration of certain aspects of the traffic control system of the present invention; and

FIG. 9 is a flow chart illustrating certain functionality of the traffic control system of the present invention.

### DETAILED DESCRIPTION OF THE INVENTION

### LIST OF REFERENCE NUMERALS (FOR PURPOSES OF REVIEW—WILL BE REMOVED FROM FINAL DRAFT)

100 control system
200 modular control unit
300 portable signaling device—flagger trailer
302 wheeled base
304 NEMA control cabinet
306 battery enclosure
307 generator
308 solar panel
310 solar panel
312 telescoping mast
314 first traffic signal
316 second traffic signal
318 support arm for second traffic signal
320 IP cameras
350 portable signaling device—node trailer
352 wheeled base
354 NEMA control cabinet
356 battery enclosure
358 solar panel
360 solar panel
362 telescoping mast
364 first display
366 second display
370 IP cameras
400 active work zone

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

Various embodiments of the present invention provide a fully automated and intelligent monitoring system designed to replace human workers (e.g., flaggers) in highway and road construction work zones. This invention utilizes computer vision (IP cameras) and artificial intelligence and establishes a wireless mesh network through various on-site traffic control devices. The system maps out critical areas of the work zone, manages and optimizes traffic in real time, communicates with drivers, and assists contractors with features that include live video monitoring and event recording, all using a minimum number of physical devices. This invention completely replaces flaggers in almost any situation, allows supervisors to monitor multiple projects at once, and provides construction firms valuable video recording and analytics of their projects. As a vision-based intelligent platform, various alternate embodiments of this invention include integrated telematics, traffic analysis, remote diagnostics, site mapping, and fleet management, and connects vehicles to heavy equipment using vehicle-to-infrastructure (V2I) communications. The system and devices of the present invention create an intelligent work zone that is similar to smart infrastructure/smart roads initiatives, but that exists within a construction zone. Managing traffic and replacing/eliminating flaggers in works zones is an important aspect of this invention; however, the present invention is essentially a robotic system for monitoring and managing work zones, with embedded artificial intelligence for controlling traffic. The system may be employed for any kind of roadside work involving temporary lane closures, including paving, water mains and gas lines for utilities, tree trimming for power lines, cable laying for Internet providers, etc. Further application for the traffic control system may be traffic control for mining, security checkpoints such as entrance gates for military bases, or for government or private facilities, highway toll booths, railroad crossings, pedestrian crossings, etc.

Prior art traffic controlling systems may involve the remote controlling of portable traffic signals for improving the performance of such signals as traffic conditions change over time. Cellular networks may be utilized to change one or more timers on traffic signals from a remote location. The present invention utilizes remote signaling units that include cameras; however, unlike other systems, this invention processes information and changes the timers on portable signaling units based on real-time sensor data received from within a site of interest. This invention also includes artificial intelligence (AI) or machine learning and has the ability, based on the use of predetermined algorithms (e.g., adaptive traffic algorithms, or alternately, real-time adaptive algorithms), to automatically adjust the functioning of remote portable signaling units to accommodate vehicles entering and leaving a work zone from various side entrances and alternate exits (e.g., side streets and driveways). As described in detail below, traffic flow through construction and work zones is accomplished by using a series of wireless sensor nodes/smart controllers and portable signaling devices.

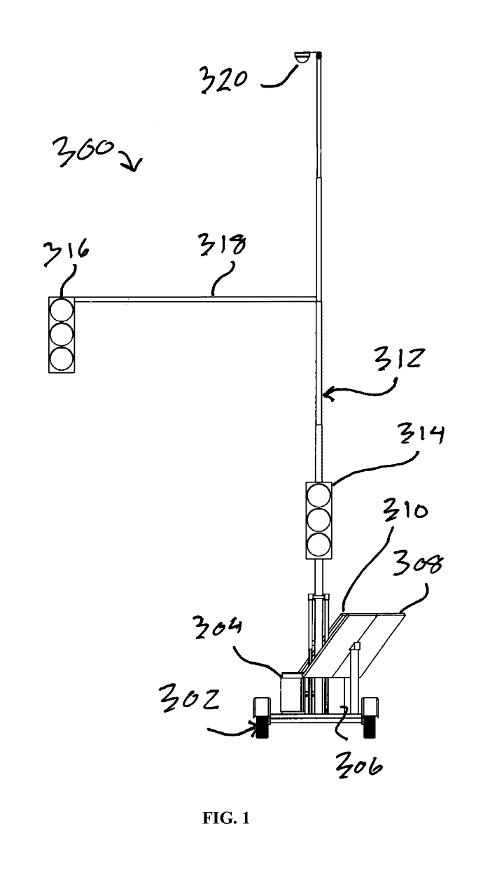

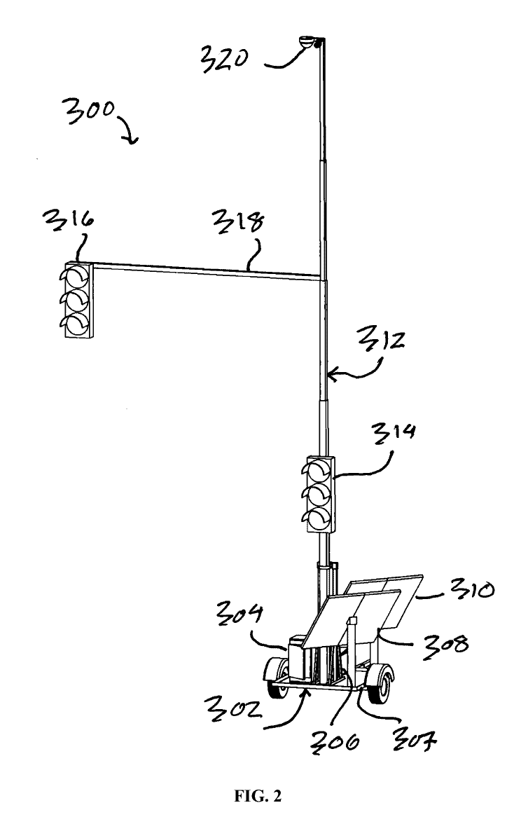

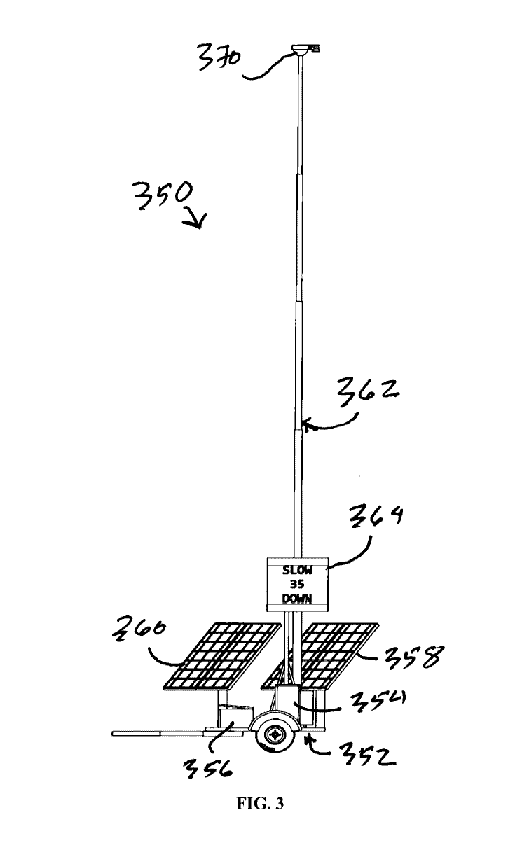

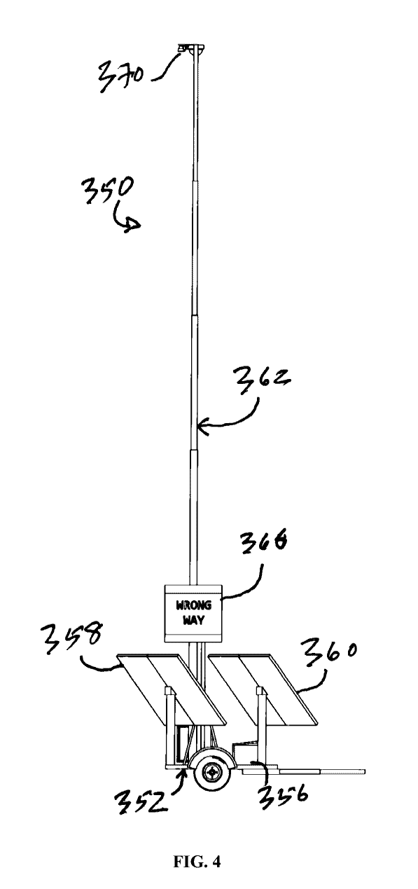

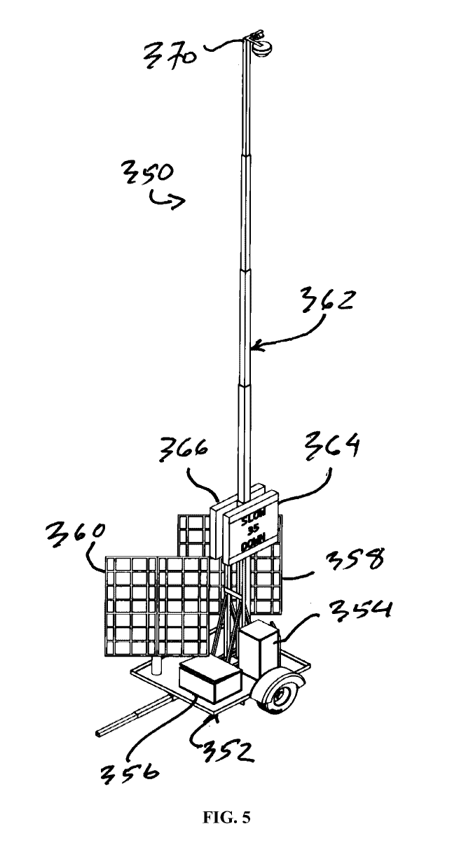

With reference to FIGS. 1-2, portable signaling device 300 is referred to as a “flagger trailer” and includes wheeled base (trailer) 302, upon which the following components are mounted: NEMA (National Electrical Manufacturers Association) control cabinet 304 (which may house a microprocessor-based controller for implementing the control algorithms discussed herein); battery enclosure 306; generator 307; first solar panel 308; second solar panel 310; telescoping mast 312; first traffic signal 314 (e.g., red to indicate stop, green to indicate to proceed, or yellow to indicate caution), which is mounted on telescoping mast 312; second traffic signal 316 (e.g., red to indicate stop, green to indicate to proceed, or yellow to indicate caution), which is mounted on support arm 318, which is attached to telescoping support mast 312; and IP camera(s) 320. With reference to FIGS. 3-5, portable signaling device 350 is referred to as a “node trailer” and includes wheeled base (trailer) 352; NEMA control cabinet 354 (which may house a microprocessor-based controller for implementing the control algorithms discussed herein); battery enclosure 356; first solar panel 358; second solar panel 360; first display 364; second display 366; and IP camera(s) 370. First and second displays 364 and 366 may include LCD screens or other types of screens and are configured as variable message signs (VMS) that are mounted so as to be visible to both directions of traffic. These signs will typically display messages such as ‘Wrong Way” and “Drive Slow”, but may also display warning messages during emergencies. Alternately VMS signs may indicate “Your Speed” or other information.

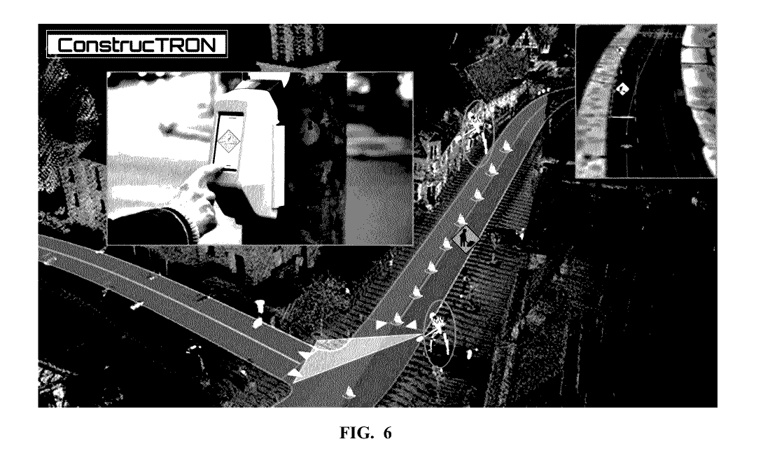

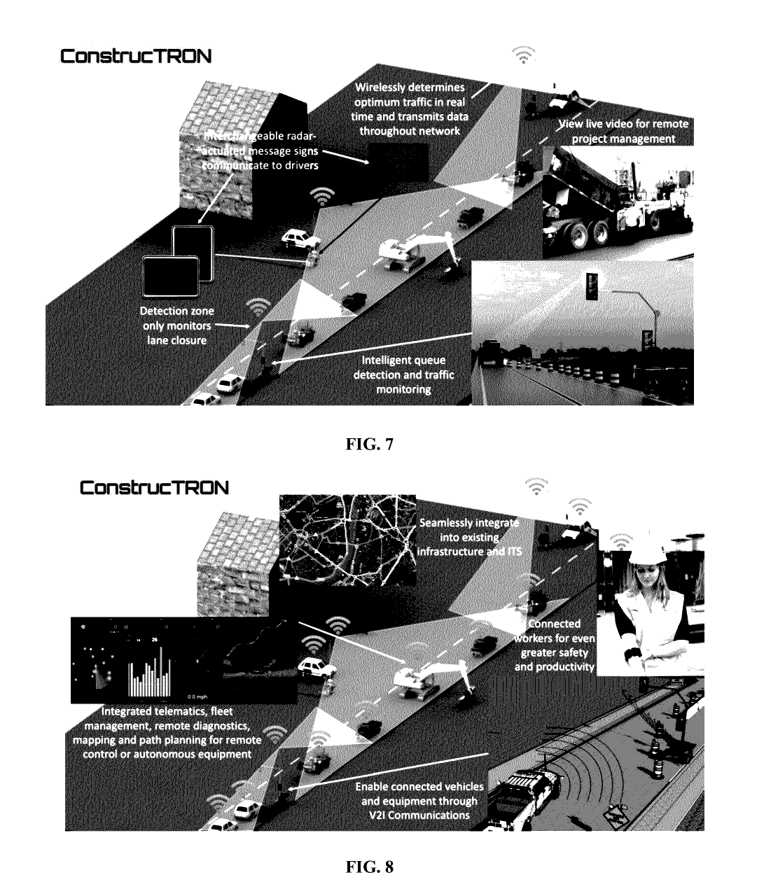

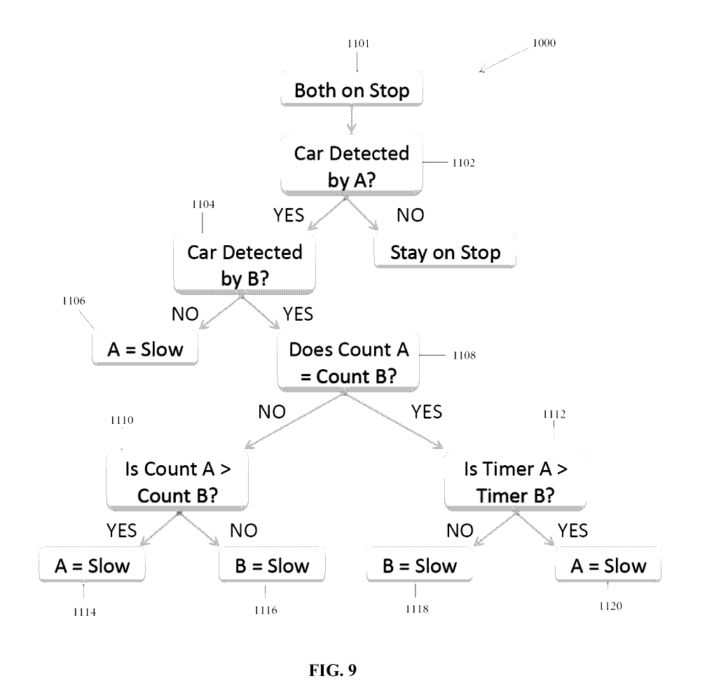

With reference to the Figures, in an exemplary embodiment of the present invention, which is referred to as the “ConstrucTRON Robotic Traffic Control System™”, system 100 includes a wireless network of modular sensors and controllers, coupled with embedded computer vision and machine learning, for purposes of monitoring and controlling traffic into and through roadside work zones. Exemplary modular control units 200 (which cooperate with the portable signaling devices to function as network nodes) typically include a single-board computer (SBC), an embedded IoT gateway, cellular network connectivity, 2.4/5 GHz and 900 MHz RF modules, touchscreen display, and multiple cameras. Such devices are solar-powered and include battery backup. These modular devices integrate with portable traffic signals 300 and 352 (referred to herein as “nodes”) which include LED arrows and changeable message signs for communicating proper traffic flow to drivers of vehicles passing through a monitored work zone. Unlike systems that are timer-based or remote-controlled from a central control center, the traffic management system of the present invention adapts in real time to constantly optimize traffic flow, is capable of incorporating multiple entrances and exits (such as driveways and side streets) into its real-time traffic algorithms, and handles all necessary processing on-site within the work zone. Again with reference to FIGS. 1-9, in an exemplary embodiment, control system 100 operates as described below.

In a first general step, a first modular control device 200 is attached to a first portable signaling device 300 and placed at one end of active work zone 400, wherein one traffic lane of the work zone has been closed. A second modular control device 200 is attached to a second portable signaling device 300 and placed at the opposite end of active work zone 400. Additional modular control devices 200 and portable signaling devices 350 may be positioned within active work zone 400 based on the existence of additional or multiple entrances and exits to work zone 400, and/or if work zone 400 is greater in length than the range of first modular control unit 200.

In a second general step, as each modular control unit 200 is powered on (i.e., activated), a mesh network is automatically formed between the control units and a user of control system 100 then defines detection zones at each modular control unit 200 when prompted to do so on the touchscreen display of each device. These detection zones are used for queuing areas within active work zone 400 for placement and operation of portable traffic signals 300, and for lane detection and vehicle tracking within active work zone 400. Defining the detection zones is typically the only initial input required for control system 100, after which the system functions autonomously.

As will be appreciated by one of ordinary skill in the art, a mesh network, such as that used with the present invention, is a network topology in which each node within the network relays data for the network. All mesh nodes cooperate in the distribution of data in and across the network. Mesh networks can relay messages using either a flooding technique or a routing technique. Using the routing technique, a message is propagated along a path by hopping from node to node until it reaches its destination. To ensure the availability of all paths, the network must allow for continuous connections and must reconfigure itself around broken paths, should they occur, using self-healing algorithms such as Shortest Path Bridging. Self-healing permits a routing-based network to operate when a node breaks down or when a connection becomes unreliable. As a result, a mesh network is typically quite reliable, as there is often more than one path between a source and a destination in the network. Although mostly used for wireless applications, this approach may be used with wired networks and with software interactions. A mesh network in which the nodes are all connected to each other is referred to as a fully connected network.

In a third general step, initially, both portable traffic signals 300 display red. Internet protocol camera 320, which is mounted on first portable traffic signal 300 detects vehicles approaching one end of active work zone 400. First modular control unit 200, which is also mounted on first portable traffic signal 300 communicates with second modular control unit 200 using a 900 MHz radio to determine if there are vehicles at or approaching the opposite end of active work zone 400. If vehicles are determined to be approaching both ends of active work zone 400, adaptive traffic algorithms that are embedded in the network nodes determine which end of work zone 400 is to be given priority with regard to traffic access. If no traffic is detected at the opposite end of active work zone 400, first portable traffic signal 300 is given priority and changes display 314/316 from red to green.

As will be appreciated by one of ordinary skill in the art, an Internet protocol camera or IP camera, such as that used with the present invention, is a type of digital video camera commonly employed for surveillance that, unlike analog closed circuit television (CCTV) cameras, is capable of sending and receiving data by way of a computer network and the Internet. Although cameras that offer this functionality are typically considered to be “webcams”, the term “IP camera” or “netcam” is usually applied only to those cameras used for surveillance. Centralized IP cameras require a central network video recorder (NVR) to handle recording, video and alarm management; and decentralized IP cameras do not require a central NVR, as such cameras have recording function built-in and can thus record directly to any standard storage media, such as SD cards, NAS (network-attached storage), or a PC/server. The IP cameras of this invention combine real-time video surveillance and embedded vision analytic software to map out road construction sites and lane closures for traffic management using motion tracking, object detection, and lane detection algorithms. The IP cameras of this invention are typically connected to embedded vision processors (DSP's, FPGA's) and to the Internet at all times (or at predetermined intervals), to provide individual analytics at each node, and to transmit the respective video by way of wireless data link and communicate between stations to allow for smooth transitions between cameras.

In a fourth general step, display 314/316 on first portable traffic signal 300 remains green until no further vehicles are detected or until its programming concludes that it has run past a predetermined period of time, then it will display a fixed-time yellow signal before switching back to red. For any modular control units 200 positioned in the middle of active work zone 400 that are not attached portable traffic signals 300, such devices will display an LED arrow or message alerting drivers which direction traffic is proceeding through active work zone 400.

In a fifth general step, as vehicles enter active work zone 400 and pass first portable traffic signal 300, a second camera mounted on first portable traffic signal 300 tracks the vehicles as they pass into active work zone 400, counts of the vehicles, stores the count information for a predetermined period of time, and then relays this information to each modular control unit 200 that has been positioned within active work zone 400. If a vehicle leaves a lane closure for any reason, or if another vehicle enters the lane closure from another entrance, the camera will detect this, update the count, and send the information again. Vehicles are only tracked in the available lane so as to eliminate background noise and allow video streams to be used for other purposes. The fifth general step described above is repeated for each modular control units 200 in control system 100. As vehicles enter each camera's field-of-view, the modular control units 200 connected to the cameras double check the vehicle count and make this information available to all other modular devices in control system 100 to ensure accuracy.

Eventually, all vehicles from the first end of active work zone 400 leave the work zone. Immediately upon clearance of these vehicles, second portable traffic signal 300 is switched to green, the LED arrows in the middle of active work zone 400 reverse, and the cycle repeats itself If, for whatever reason, a vehicle is travelling the wrong direction within active work zone 400, or stalls in the middle of a closed lane, control system 100 will switch the portable traffic signals 300 at both ends of active work zone 400 to red lights, flash warning beacons, and send SMS alerts to notify site workers of the problem. Once the blocked lane is clear, control system 100 will resume normal operation. If contractors operating within active work zone 400 need to temporarily stop traffic flow at both ends of active work zone 400 for a construction vehicle or any other reason, a manual remote-control can be used to prevent access to both sides of active work zone 400 until the hazard has been removed. During this time, the adaptive traffic algorithms which are part of control system 100 will continue to determine optimum traffic flow and select the proper end of active work zone 400 to re-activate first. The same functionality may be used for determining emergency vehicle priority through a defined traffic zone.

A separate, unaltered video stream from any IP camera 320 within control system 100 may be stored locally on an external hard drive, or accessed remotely by the system's cellular gateway. The 2.4/5 GHz radio modules can serve as Wi-Fi access points for workers, if desired. Modular control units 200 include GPS capabilities and can integrate into other Intelligent Transportation Systems (ITS) applications, such as statewide traffic maps, traffic analytics, and other work zone traffic management systems (queue warning systems, etc.). Control system 100 is also capable of communicating updated traffic information (such as proper path planning data), directly to connected vehicles, including to contractor vehicles and heavy equipment. As previously stated, this may be accomplished using vehicle-to-infrastructure (V2I) communications.

As will be appreciated by one of ordinary skill in the art, vehicle-to-infrastructure (V2I) communications for safety is the wireless exchange of critical safety and operational data between vehicles and roadway infrastructure, intended primarily to avoid motor vehicle crashes. Vehicle-to-infrastructure technologies are intended to offer certain safety features such as providing drivers with additional warnings when traffic signals are about to change and warnings that help reduce collisions at intersections. In addition, these technologies offer potential mobility and environmental benefits; for example, they can collect, analyze, and provide drivers with data on upcoming roadway and traffic conditions and suggest alternate routes when roadways are congested.

In some embodiments, control system 100 includes an Automatic Number Plate Recognition (ANPR) system. Also, because control system 100 is typically connected to the Internet or other similar wide-area network at all times, control system 100 provides a connection for cameras to access the Internet, e.g., Cloud servers, and allow users to tap into live video feeds at any time.

In one embodiment of this invention, the following operational method is executed by control system 100. A pair of nodes 300, designated as node A and node B are initially set to the STOP mode. Vehicle traffic is detected in work zone 400 approaching either or both nodes by IP cameras 320. Cameras 320 are configured with motion tracking and vehicle detection algorithms implemented in the controller in cabinet 304. Node A may be calculated or designated to have greater priority than node B, and node-A actuates its traffic signal and gate first. As vehicles enter work zone 400, another wide-lens IP camera 320 on node A begins tracking each vehicle and counting the vehicles as they enter the work zone past node A. Node B may optionally display a “Please Wait” message split-screened with the current live video feed to ensure drivers that the system is working properly.

With reference to FIG. 9, a mobile application is disclosed for wireless manual or remote control of the devices in unusual or emergency situations. The application allows workers to halt both flaggers in the case of an accident, or when moving heavy equipment. If there is an error in the device, the app will also allow a worker to remotely operate the devices, similar to current AFAD's. Initially, both portable signaling devices (nodes) referred to as A and B, are set to a stop mode at 1101. The system then proceeds at step 1102 to determine if or when a vehicle is detected at node A. If a vehicle is detected at step 1102, then the system 1000 proceeds to step 1104 to determine if a vehicle has been detected by node B. If no car is detected by node B, the system proceeds to step 1106 and sets the signal at node A to SLOW. If a vehicle is detected by node B, then the system proceeds to step 1108 and determines, for example, by using an adaptive traffic algorithm, or alternately, a real time adaptive traffic algorithm, if the vehicle count of node A is equal to the vehicle count at node B. If the vehicle count at node A does not equal the vehicle count at node B, the system proceeds to step 1110 and determines if the vehicle count for node A is greater than the vehicle count at node B. If at step 1108 the vehicle count for node A equals node B, then the system proceeds to step 1112, and determines if the timer for node A is greater than or equal to the timer for node B. Returning to step 1110, if the vehicle count for node A is greater than the vehicle count at node B, then node A is set to slow at step 1114, and if the vehicle count for node A is not greater than the count at node B, then node B is set to slow at step 1116. At step 1112, if the timer for node A is greater than or equal to the timer for node B, then node A is set to slow at step 1120. Otherwise, node B is set to slow. In another embodiment a conventional 3-color traffic signal may be substituted for the exemplary rotating STOP/SLOW sign because it is located in a workzone wherein drivers are required to proceed slowly. It is also noted that FIG. 9 describes a general schematic of the system, which may include more complex electronics and software.

It should be noted that although the Figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

As noted above, embodiments within the scope of the present application include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

While the present invention has been illustrated by the description of exemplary embodiments thereof, and while the embodiments have been described in certain detail, there is no intention to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the general inventive concept.

What is claimed:

1. A traffic control system, comprising:
(a) first modular control unit;
(b) a first portable signaling device in communication with the first modular control unit, wherein the first portable signaling device includes at least one display and at least one vehicle-detecting camera;
(c) a second modular control unit;
(d) a second portable signaling device in communication with the second modular control unit, wherein the second portable signaling device includes at least one display and at least one vehicle-detecting camera; and
(e) a mesh network formed between the first modular control unit and the second modular control unit, wherein the mesh network enables completely autonomous functioning of the first portable signaling device in combination with the second portable signaling device for controlling traffic within a work zone in which the first and second portable signaling devices have been placed.

2. The traffic control system of claim 1, further comprising at least one additional modular control unit and at least one additional portable signaling device in communication with the at least one additional modular control unit.

3. The traffic control system of claim 1, wherein each modular control unit further includes a single board computer, an embedded IoT gateway, cellular network connectivity, 2.4/5 GHz and 900 MHz RF modules, a touchscreen display, and at least one optical sensor.

4. The traffic control system of claim 1, wherein each modular control unit is solar powered.

5. The traffic control system of claim 1, wherein each portable signaling device is solar powered.

6. The traffic control system of claim 1, wherein the vehicle-detecting cameras are internet protocol cameras.

7. The traffic control system of claim 1, wherein each modular control unit includes software that further includes adaptive traffic algorithms or real-time adaptive algorithms.

8. The traffic control system of claim 1, wherein the at least one display on each of the portable traffic signaling devices is a traffic light.

9. The traffic control system of claim 1, wherein the at least one display on each of the portable traffic signaling devices is a digital display.

10. A traffic control system, comprising:
(a) first modular control unit;
(b) a first portable signaling device in communication with the first modular control unit, wherein the first portable signaling device includes at least one display and at least one vehicle-detecting camera;
(c) a second modular control unit;
(d) a second portable signaling device in communication with the second modular control unit, wherein the second portable signaling device includes at least one display and at least one vehicle-detecting camera;
(e) at least one additional modular control unit and at least one additional portable signaling device in communication with the at least one additional modular control unit; and
(f) a mesh network formed between the modular control units, wherein the mesh network enables completely autonomous functioning of the signaling devices in combination with one another for controlling traffic within a work zone in which the portable signaling devices have been located.

11. The traffic control system of claim 10, wherein each modular control unit further includes a single board computer, an embedded IoT gateway, cellular network connectivity, 2.4/5 GHz and 900 MHz RF modules, a touchscreen display, and at least one optical sensor.

12. The traffic control system of claim 10, wherein each modular control unit is solar powered.

13. The traffic control system of claim 10, wherein each portable signaling device is solar powered.

14. The traffic control system of claim 10, wherein the vehicle-detecting cameras are internet protocol cameras.

15. The traffic control system of claim 10, wherein each modular control unit includes software that further includes adaptive traffic algorithms or real-time adaptive algorithms.

16. The traffic control system of claim 10, wherein the at least one display on each of the portable traffic signaling devices is a traffic light.

17. The traffic control system of claim 10, wherein the at least one display on each of the portable traffic signaling devices is a digital display.

18. A traffic control system, comprising:
(a) first modular control unit, wherein the first modular control unit includes software that further includes adaptive traffic algorithms or real-time adaptive algorithms;
(b) a first portable signaling device in communication with the first modular control unit, wherein the first portable signaling device includes at least one display and at least one vehicle-detecting internet protocol camera;
(c) a second modular control unit, wherein the second modular control unit includes software that further includes adaptive traffic algorithms or real-time adaptive algorithms;
(d) a second portable signaling device in communication with the second modular control unit, wherein the second portable signaling device includes at least one display and at least one vehicle-detecting internet protocol camera;
(e) at least one additional modular control unit and at least one additional portable signaling device in communication with the at least one additional modular control unit, wherein the at least one additional modular control unit includes software that further includes adaptive traffic algorithms or real-time adaptive algorithms; and
(f) a mesh network formed between the modular control units, wherein the mesh network enables completely autonomous functioning of the signaling devices in combination with one another for controlling traffic within a work zone in which the portable signaling devices have been located.

19. The traffic control system of claim 18, wherein each modular control unit further includes a single board computer, an embedded IoT gateway, cellular network connectivity, 2.4/5 GHz and 900 MHz RF modules, a touchscreen display, and at least one optical sensor.

20. The traffic control system of claim 18, wherein each modular control unit and each portable signaling device is solar powered.

21. The traffic control system of claim 18, wherein the at least one display on each of the portable traffic signaling devices is a traffic light.

22. The traffic control system of claim 18, wherein the at least one display on each of the portable traffic signaling devices is a digital display.
